(19) United States
(12) Patent Application Publication
(10) Pub. No.: US 2019/0242968 A1
(43) Pub. Date: Aug. 8, 2019

(54) Joint Entity and Object Tracking Using an RFID and Detection Network

(71) Applicant: Mojix, Inc., Los Angeles, CA (US)

(72) Inventor: Ramin Sadr, Los Angeles, CA (US)

(73) Assignee: Mojix, Inc., Los Angeles, CA (US)

(21) Appl. No.: 16/210,755

(22) Filed: Dec. 5, 2018

Related U.S. Application Data
(63) Continuation of application No. 15/585,117, filed on May 2, 2017, now abandoned.
(60) Provisional application No. 62/330,761, filed on May 2, 2016.

(51) Int. Cl. G01S 5/02; G01S 13/86; G01S 13/74; G01S 19/42; G01S 5/00; G06Q 10/04; G01S 13/87

(52) U.S. Cl. CPC G01S 5/0263; G01S 13/867; G01S 13/74; G01S 19/42; G01S 2013/468; G06Q 10/047; G01S 5/021; G01S 13/878; G01S 5/0036

(57) ABSTRACT

Several embodiments of the invention provide for a system and processes for joint entity and object tracking using RFID and a detection network. The use of RFID and a detection network allows for the efficient detection, tracking, and recording of an entity path. Various embodiments of the invention allow the system to track the paths of entities through a space and to monitor the entities' interactions with objects in the space. In addition to tracking entities' paths, the system of some embodiments associates each entity with various objects that each entity interacts with, and uses targeted reads of the associated objects to distinguish and verify the paths associated with each entity. The paths and interactions of the entities with objects in the space are then recorded and analyzed to provide insight about the different entities and about their interactions within the space.

### CROSS REFERENCE TO RELATED APPLICATIONS

This application is a continuation of U.S. patent application Ser. No. 15/585,117, entitled “Joint Entity and Object Tracking Using an RFID and Detection Network” to Ramin Sadr, filed May 2, 2017, which application claims priority under 35 U.S.C. § 119(e) to U.S. Provisional Application Ser. No. 62/330,761 filed May 2, 2016, entitled “Joint Person and Object Tracking Using an RFID and Camera Network” to Ramin Sadr. The disclosures of application Ser. Nos. 15/585,117 and 62/330,761 are hereby incorporated by reference in their entirety.

### FIELD OF THE INVENTION

The present invention relates generally to Radio Frequency Identification (RFID) and detection systems, such as (but not limited to) cameras and location sensors, and more specifically to the tracking and identification of entities and objects using such systems.

### BACKGROUND

Customer data that quantifies traffic through a retail store can provide valuable information for business decisions, for example, in designing a store layout or analyzing how particular items are marketed by their displays. Powerful insight can be gained through information such as where items are within the store, the layout of the store, where customers are walking, dwell time (i.e., how long customers are staying in a particular area), and when customers are picking up or putting down items. Such information can be referred to as customer analytics or retail analytics.

### SUMMARY OF THE INVENTION

Systems and methods for joint entity and object tracking using an RFID system and a detection network in accordance with embodiments of the invention are disclosed. In one embodiment of the invention, a method for monitoring entities in a physical space includes detecting a set of entities in the physical space using a detection system including a plurality of cameras having different fields of view, tracking a path for each entity of the set of entities through the physical space based on the detection system, performing a set of tag reads to detect movement of tags proximate to a region in which a particular entity is detected by the detection system, associating a particular tag with the particular entity and a corresponding path of the particular entity based on the detected movement of the particular tag, and recording the corresponding path for each entity based on the set of tag reads, the detected presence of the set of entities, and tags associated with at least one entity of the set of entities. The detection system of some such embodiments detects the presence of entities within each camera's field of view.

In a further embodiment, the method further includes transmitting interrogation signals addressed to a particular tag associated with a particular entity, computing location data from response signals received from the particular tag associated with the particular entity, and updating the corresponding path for the particular entity based on the computed location data.

In another embodiment, the detection system further includes a set of beacons for a Light-Fidelity (Li-Fi) system, wherein detecting a set of entities comprises receiving detection data based on the set of beacons from mobile devices associated with each entity of the set of entities.

In still another embodiment, the detection system further includes a set of motion detectors, wherein detecting a set of entities includes using the set of motion detectors to detect motion of the entities within the physical space.

In a still further embodiment tracking a path for each entity includes identifying bounded regions within the field of view of each camera of the plurality of cameras, detecting the presence of a particular object within a bounded region of the field of view of a particular camera of the plurality of cameras, determining movements across boundaries between bounded regions, and storing the path as a sequence of transitions across boundaries of the bounded regions, where the description of the transition includes the direction of the transition.

In yet another embodiment, storing the trajectories includes building a sensor word to express the path of the entity based on the transitions between the boundaries of the bounded regions.

In a yet further embodiment, performing the set of tag reads to detect movement of a tag includes determining that the tag has moved based on radiometric properties of response signals received in response to a set of interrogation signals.

In another additional embodiment, the radiometric properties include at least one of a frequency and phase offsets of the response signals.

In a further additional embodiment, the set of interrogation signals includes multiple interrogation signals sent to the tag at a single frequency.

In another embodiment again, the set of interrogation signals includes multiple interrogation signals sent to the tag at multiple, different frequencies.

In a further embodiment again, performing the set of tag reads includes reading a tag identifier from a response signal associated with each tag and associating the particular tag with the particular entity based on the detected movement of the particular tag includes associating the tag identifier for the particular tag with the entity.

In still yet another embodiment, the method further includes, upon associating a tag with an entity, detecting the entity in a particular region of the physical space, targeting interrogation signals for the associated tag in the particular region of the physical space, and analyzing response signals from the targeted interrogation signals to infer movement of the entity based on movement of the associated tag.

In a still yet further embodiment, the method further includes, upon associating a tag with an entity, detecting the entity in a particular region of the physical space, targeting interrogation signals for the associated tag in neighboring regions of the physical space, analyzing response signals from the targeted interrogation signals to locate the tag, and identifying a step in the path of the entity based on a location of the associated tag.

In still another additional embodiment, a system for monitoring entities in a physical space includes a detection system that includes multiple cameras having different fields of view for detecting a set of entities in the physical space, a RFID reader system for performing a set of tag reads to detect movement of tags proximate to a region in which a particular entity is detected by the detection system, a path tracking system for tracking a path for each entity of the set of entities through the physical space and for associating a particular tag with the particular entity and a corresponding path of the particular entity based on detected movement of the particular tag, and a tracking database for recording the corresponding path for each entity based on the set of tag reads, the detected presence of the set of entities, and tags associated with at least one entity of the set of entities. The detection system of some such embodiments detects the presence of entities within each camera's field of view.

In a still further additional embodiment, the RFID reader system is further for transmitting interrogation signals addressed to a particular tag associated with a particular entity, and computing location data from response signals received from the particular tag associated with the particular entity, wherein the path tracking system is further for updating the corresponding path for the particular entity based on the computed location data in the tracking database.

In yet another additional embodiment, the detection system further includes a set of beacons for a Light-Fidelity (Li-Fi) system, wherein the detection system detects a set of entities by receiving detection data based on the set of beacons from mobile devices associated with each entity of the set of entities.

In a yet further additional embodiment, the path tracking system tracks a path for each entity by identifying bounded regions within the field of view of each camera of the plurality of cameras, detecting the presence of a particular object within a bounded region of the field of view of a particular camera of the plurality of cameras, determining movements across boundaries between bounded regions, and storing trajectories as a sequence of transitions across boundaries of the bounded regions, where the description of the transition includes the direction of the transition.

In yet another embodiment again, the stored trajectories are stored as sensor words that express the path of the entity based on the transitions between the boundaries of the bounded regions.

In a yet further embodiment again, the RFID reader system is further for determining that the tag has moved based on radiometric properties of response signals from the set of interrogation reads.

In another additional embodiment again, the detection system is further for, upon associating a tag with an entity, detecting the entity in a particular region of the physical space, wherein, upon detecting the entity in the particular region, the RFID reader system is further for targeting interrogation signals for the associated tag in neighboring regions of the physical space, wherein the path tracking system is further for analyzing response signals from the targeted interrogation signals to locate the tag, and identifying a step in the path of the entity based on a location of the associated tag.

Additional embodiments and features are set forth in part in the description that follows, and in part will become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

FIG. 1 is a diagram of a retail store floor plan showing a potential customer path in accordance with embodiments of the invention.

FIG. 2 is a system diagram illustrating a joint entity and object tracking system in accordance with embodiments of the invention.

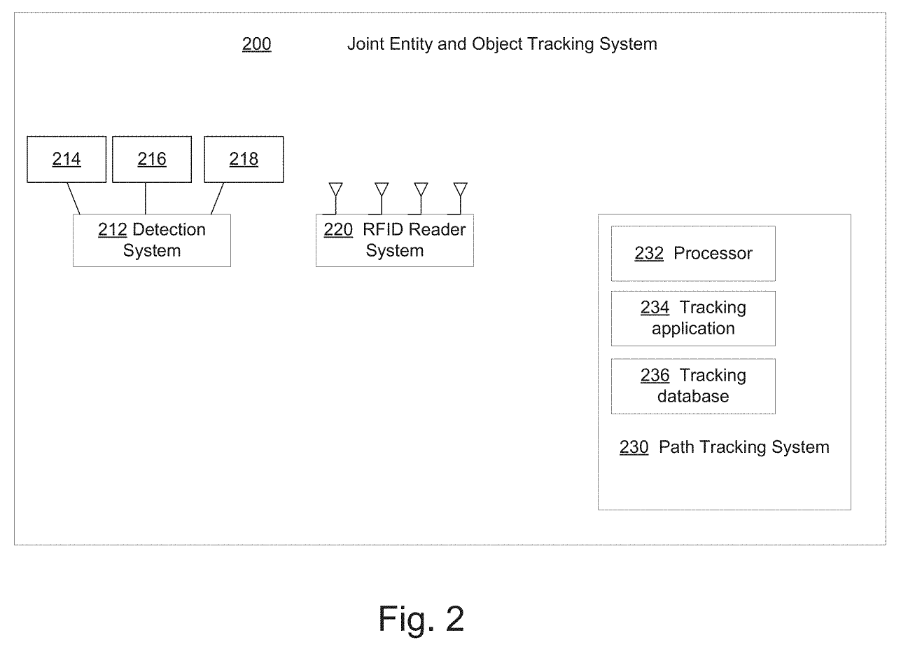

FIG. 3 is a diagram of a retail store floor plan showing potential camera and antenna locations in accordance with embodiments of the invention.

FIG. 4 is a flow chart illustrating a process for joint entity and object tracking using an RFID and camera network in accordance with embodiments of the invention.

FIG. 5 illustrates an example of joint entity and object tracking in accordance with embodiments of the invention.

FIGS. 6A and 6B are graphical illustrations showing potential simplicial complexes that can be used to describe two-dimensional areas in accordance with embodiments of the invention.

### DETAILED DISCLOSURE OF THE INVENTION

Turning now to the drawings, joint entity and object tracking using radio-frequency identification (RFID) and detection networks in accordance with various embodiments of the invention are disclosed. Several embodiments of the invention provide for systems and processes for joint entity and object tracking by fusing data received from RFID reader systems that incorporate detection networks. The use of RFID and a detection network allows for the efficient detection, tracking, and recording of an entity path.

Systems for Joint Entity and Object Tracking using RFID and a Detection Network

There are often many challenges in monitoring entities and tags in a large space, particularly as the number of tags and/or entities, as well as the size of the area increase. Various embodiments of the invention allow the system to use a detection network to detect the presence of entities within the space and track the paths of the entities through the space, while using a RFID reader system to look specifically for moving RFID tags to identify the individual entities based on their interactions with objects in the space. In addition to tracking entities' paths, the system of some embodiments associates each entity with various objects that each entity interacts with, and uses targeted reads of RFID tags affixed to the associated objects to distinguish and verify the paths associated with each entity. The ability to track detected entities using the detection network and to identify moving tags using the RFID reader system enables the system to uniquely identify individuals and their paths through the space. The system of many embodiments performs tracking of the individuals using simplicial complexes to represent the combined fields of view of the sensors in the detection network, which is more efficient than common methods using complicated machine vision and optical flow techniques. Furthermore, tracking can be performed using simplicial complexes to represent the fields of view of particular types of sensors, such as (but not limited to) cameras, without the need to perform precise spatial calibration and/or measurement of the fields of view of the sensors. The paths and interactions of the entities with objects in the space are then recorded and analyzed to provide insight about the different entities and about their interactions within the space.

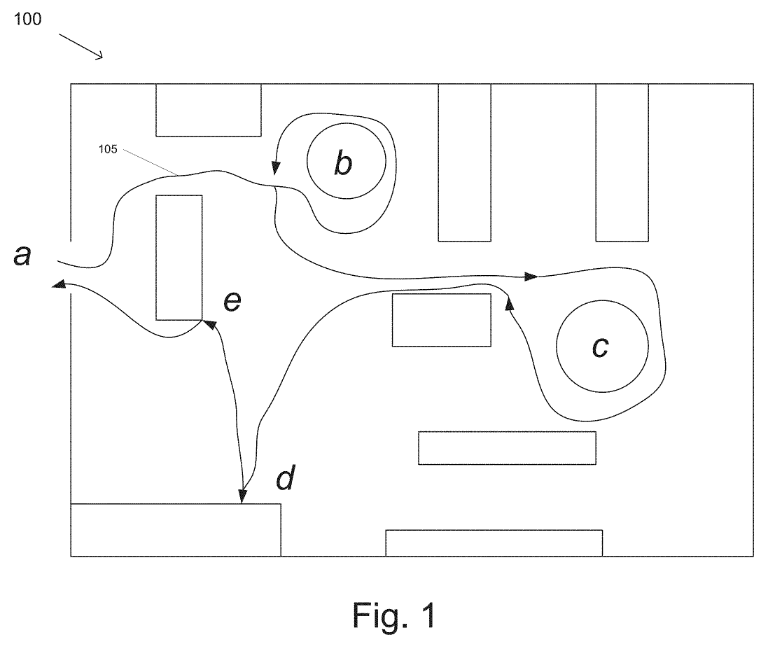

Many embodiments of the invention allow a joint entity and object tracking system to track the paths of entities, such as shoppers, through a retail floor and to monitor the shoppers' interactions with objects, such as (but not limited to) tagged items in a store. A diagram illustrating an example retail floor 100 in accordance with several embodiments of the invention is illustrated in FIG. 1. A path 105 that a customer may follow is shown with an arrow entering the store at point a, around store displays/racks at points b and c, to dressing room at point d, to check out at the point-of-sale (cashier) at point e, and finally exiting again from point a.

Traditional capture of customer analytics by full-frame video can be challenging and require large amounts of storage for the video. Many conventional methods for tracking and identifying individual entities through a crowded space require complicated and computationally expensive machine vision algorithms, or specialized hardware, such as GPS-enabled sensors, to identify the position, identity, and path of an entity through a space. Tracking interactions of identified entities with various objects within the space often requires even greater amounts of data and computational power. In addition, deployment of such a video capture system can involve precise localization and calibration of cameras to determine correspondence between the 2D images captured by the cameras and the 3D structure of the real world scene visible within the field of view of the cameras.

A joint entity and object tracking system according to several embodiments of the invention uses RFID tags in conjunction with a detection system to identify and track entities and associated objects through a space. In the illustrated embodiment, a joint entity and object tracking system 200 includes a detection system 212 that is part of an RFID reader system 220, which incorporates a path tracking system 230.

In many embodiments of the invention, detection system 212 includes one or more systems for detecting the presence of an entity in various portions or regions of the monitored space. Unlike other entity tracking systems that use complicated machine vision algorithms or specialized sensors to identify and track entities, the path tracking system of many embodiments uses a simpler presence detection system to track entities through a space. Furthermore, detection systems in accordance with many embodiments of the invention can be deployed without the need to capture precise localization information with respect to the position and orientation of the sensors (e.g. cameras) that form the detection system. As is discussed further below, detection systems in accordance with several embodiments of the invention can construct simplicial representations that capture the topological structure of the coverage of a detection system by using detections of a single target moving through the environment. The topographical representation can then be utilized by the detection system to track multiple entities within the environment. In many cases, existing machine vision algorithms struggle with the identification and tracking of individuals, particularly as the number of individuals in a space and their movement through the space increase. The tracking of specific individuals becomes increasingly complex when different cameras have different fields of view and are irregularly placed throughout the space.

Detection system 212 includes one or more detection elements 214, 216 and 218. The detection system of certain embodiments is a camera system with multiple cameras, which use machine vision processing to detect, locate, and track entities within a space. In some such embodiments, cameras are placed at the entrance(s) and exit(s) of the space and throughout the space to visually cover all areas where a customer may go. In other embodiments, the detection elements of the detection system include other types of sensor systems that can be used to locate or detect the presence of an entity in a monitored space, such as (but not limited to) a Light-Fidelity (Li-Fi) system, motion detectors, and other types of scanners.

The detection system 212 of some embodiments then collects detection data from the detection elements 214, 216, and 218. The detection data of various embodiments includes, but is not limited to, data captured in conjunction with cameras, an RFID system, a LiFi system, mobile devices, near field communication (NFC) systems, Bluetooth systems, and motion tracking sensors. In several embodiments, the detection process involves building an initial topological model by having a single entity move through a space and observing locations at which the entity is detected by the detection elements 214, 216, and 218. At each time step, the detection elements 214, 216, and 218 can compute their detections of the moving entity and can use their observations to detect bisecting lines. Observations at the regions obtained after decomposition using the bisecting lines can then be combined to determine intersections between regions within the monitored environment. These regions can then be considered simplices in a simplicial complex describing the monitored environment. The regions in which entities can be detected by different combinations of detection elements 214, 216, and 218 can be utilized by the detection system 212 to describe trajectories of entities through the monitored environment. In a number of embodiments, movement of entities through the environment is represented by a sequence of transitions between regions, where the description of a transition indicates the direction of the transition (e.g. movement from a first region to a second region). As is discussed further below, the ability to track entities moving through a monitored environment using the detection system 212 can be utilized to coordinate interrogation of RFID tags. Information collected concerning movement of RFID tags can then be utilized to identify and track entities within the monitored environment. When RFID tags are utilized to identify an entity, ambiguity that might otherwise result when multiple entities are moving within an environment monitored by detection elements 214, 216, and 218 can be resolved.

In many embodiments, RFID reader system 220 includes at least one reader configured to transmit and receive signals via a network of transmit and/or receive antennas in order to read RFID tags in a monitored area. Several embodiments utilize two or more antennas. Antennas may be dedicated, separate, transmit and receive antennas or may be combined transmit/receive antennas. RFID reader systems in accordance with some embodiments of the invention may utilize a phased antenna array such as those described in U.S. Pat. No. 8,768,248 entitled “RFID Beam Forming System” to Sadr, the disclosure from which relevant to antenna arrays having multiple elements is hereby incorporated by reference in its entirety. RFID reader systems in accordance with many embodiments of the invention may utilize distributed antennas such as those described in U.S. Pat. No. 8,395,482 entitled “RFID systems using distributed exciter network” to Sadr et al., the disclosure from which relevant to distributed antenna architectures is hereby incorporated by reference in its entirety. While specific RFID reader systems are described herein, it should be appreciated that any of a variety of RFID reader systems incorporating different architectures can be utilized to read RFID tags within different read zones within a monitored environment as appropriate to the requirements of a given application in accordance with various embodiments of the invention.

In several embodiments, the reading of RFID tags involves timing and phase uncertainty in the backscattered signal returned from a tag. Several RFID reader systems in many embodiments of the invention detect timing and phase uncertainty using techniques such as those described in U.S. Pat. No. 7,633,377 entitled “RFID Receiver” to Sadr, the disclosure from which relevant to detecting time and phase uncertainty of a backscattered signal is hereby incorporated by reference in its entirety.

RFID tags can be used to identify an object, determine the location of the tagged object and detect events such as (but not limited to) movement of the tagged object. An RFID reader system in accordance with many embodiments of the invention sends interrogation signals to interrogate tags associated with different objects, and reads response signals that are returned from the tags in response to the interrogation signals. The response signals of many embodiments include tag data including (but not limited to) identification information that identifies the tag and/or an object with which the tag is associated. In some embodiments, the detection system 212 can communicate with tags and/or other tracking devices that are capable of determining location through various means, such as (but not limited to) acquiring location data using a global positioning system (GPS) receiver.

The tag data of some embodiments includes data that is calculated based on characteristics of the response signals received from the tags. For example, the RFID reader system of many embodiments analyzes radiometric data, such as (but not limited to) the frequency and/or phase of the response signals from the RFID tags to locate a tag within the space, to detect movement of a tag and/or to identify a trajectory (i.e., direction and/or velocity of travel) of the tag. RFID tag location may be determined by measuring phase differences observed from backscattered signals when a tag is interrogated at different frequencies as described in U.S. Pat. No. 8,072,311 entitled “Radio frequency identification tag location estimation and tracking system and method” to Sadr et al., the disclosure from which relevant to tag location estimation is hereby incorporated by reference in its entirety. Movement of a tag may similarly be determined based upon observed phase differences when an RFID tag is repeatedly interrogated using interrogation signals transmitted using the same frequency.

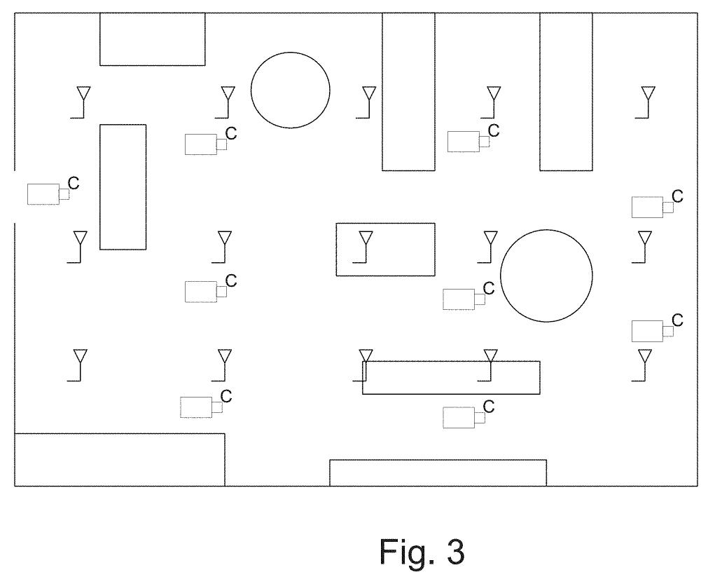

In order to provide the highest level of coverage, the detection sensors and RFID antennas of the joint entity and object tracking system may be distributed throughout the monitored area. FIG. 3 illustrates the floor plan of the retail space of FIG. 1 overlaid to show potential locations for detection sensors (cameras, in this example) and antennas. Although the cameras and antennas are placed at regular intervals in this example, other embodiments allow for other layouts. For example, in some embodiments, the cameras are placed in more strategic locations, such as (but not limited to) near entrances and exits, along high traffic flow areas, and areas with low visibility. The layouts for the detection sensors and RFID system of some embodiments do not provide visibility to the entire monitored area, leaving “holes” in the coverage area, or may provide overlapping coverage in other areas. In many embodiments, the detection system can operate without precise information concerning the location of the cameras and/or RFID reading infrastructure. In several embodiments, an object tagged with an RFID tag is moved through a monitored area and observations of the object and/or the RFID tag is utilized to define regions within the environment.

Path tracking system 230 of many embodiments analyzes the detection data and RFID data of detection system 212 and RFID reader system 220 to track a route traveled by an entity and associated items through a monitored space. In many embodiments, the path is defined as a series of directional transitions from regions defined during an initial setup process. Path tracking system 230 as illustrated in this example includes one or more processors 232 and a tracking application 234 that may be stored in memory or in firmware and configures the one or more processor(s) to perform joint entity and object tracking processes such as those described further below.

In several embodiments, the path tracking system 230 tracks the paths of entities through a space based on detections of the entities by detection system 212, but uses RFID data of the RFID reader system 220 to identify entities as they travel along divergent routes. In certain embodiments, path tracking system 230 uses RFID data from RFID reader system 220 to provide secondary location information, which can be used for various purposes, such as (but not limited to) detecting movement of the tag, identifying a trajectory (i.e., direction and/or velocity of travel) of a tag, and associating an entity detected by a detection system with a particular tag. For example, in some embodiments, a particular RFID tag's location, identified by RFID reader system 220, is compared with locations for entities detected by detection system 212 to determine a particular entity with which to associate the particular RFID tag.

Unlike other entity tracking systems that use complicated machine vision algorithms or specialized sensors to identify the various entities, the path tracking system of many embodiments can use a simpler presence detection system to track entities through a space, and can use the location data from the RFID data for a finer-grained identification of the detected entities based on the corresponding movement of associated tags, particularly in the case when it is difficult for the detection system 212 to differentiate between multiple entities. For example, in certain embodiments, a tag is associated with a person, and their path through a crowded retail space is identified based on the detection of people by a camera system in conjunction with RFID data that describes the movement of items that the person is transporting (e.g. carrying or has added to a basket or shopping cart).

In certain embodiments, the path tracking system 230 stores the tracked paths of the various detected entities in tracking database 236. In several embodiments, each entity's route through the space is tracked using mathematical representations, and in particular, concepts from homology and homotopy, to achieve much greater efficiency similar to those described in Aghajan et al. “Multi-Camera Networks: Principles and Applications” (2009), Chapter 4 of which is entitled “Building an Algebraic Topographical Model of Wireless Camera Networks” the disclosure from which including the disclosure related to the construction of simplicial complexes describing a monitored environment and the tracking of objects moving through a monitored environment is hereby incorporated by reference in its entirety. In many embodiments, the paths are represented and stored as sensor words, described in further detail below.

While a vision-based system is described above, any of a variety of systems for locating and tracking an entity in space can be utilized as appropriate to the requirements of specific applications.

### Processes for Joint Entity and Object Tracking Using RFID

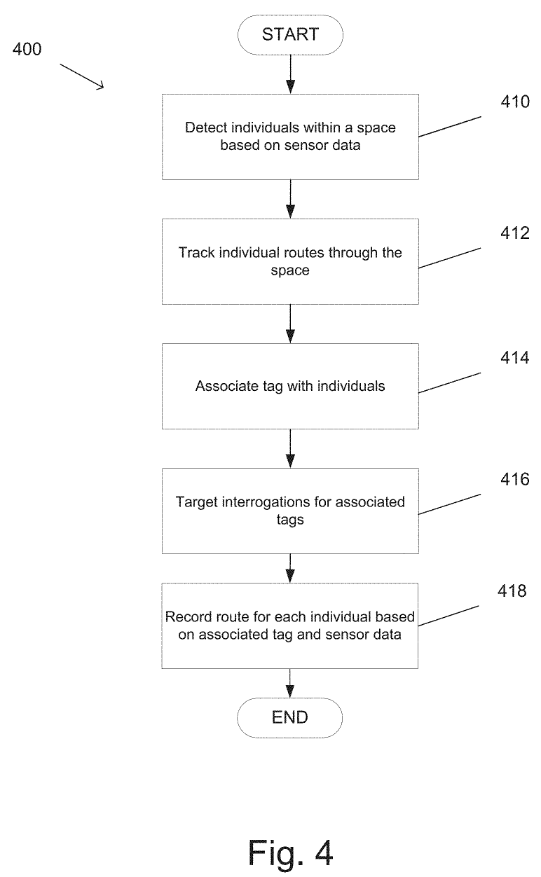

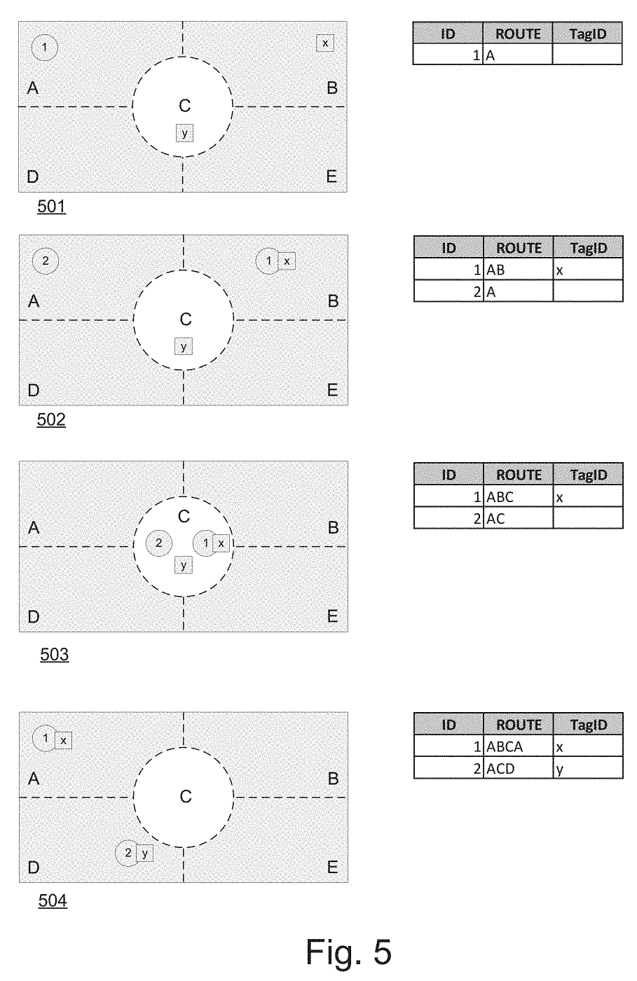

A process for tracking a person and object within a discrete space using a joint entity and object tracking system in accordance with embodiments of the invention is illustrated in FIG. 4 with reference to FIG. 5. An example of joint entity and object tracking in accordance with embodiments of the invention is illustrated in FIG. 5. In many embodiments, the space is monitored using a detection system and a RFID reader system, similar to those described above. Elements of these systems (e.g., RFID antennas, cameras, etc.) are not shown in the example of FIG. 5 for clarity and ease of illustration, but one skilled in the art will understand how such systems can be used to perform joint entity and object tracking in accordance with the example of this figure.

Referring back to FIG. 4, the process 400 of certain embodiments detects (410) individuals within a space based on detection data. The process 400 of some embodiments begins when a person is first detected in the monitored area using a vision system. The detection data of various embodiments includes, but is not limited to, data captured in conjunction with cameras, an RFID system, a LiFi system, mobile devices, near field communication (NFC) systems, Bluetooth systems, and/or motion tracking sensors. In many embodiments, the joint entity and object system includes a vision system that includes N cameras and/or other devices having visual coverage of the space. A detection system can be a network of one or more cameras and/or other image capture devices.

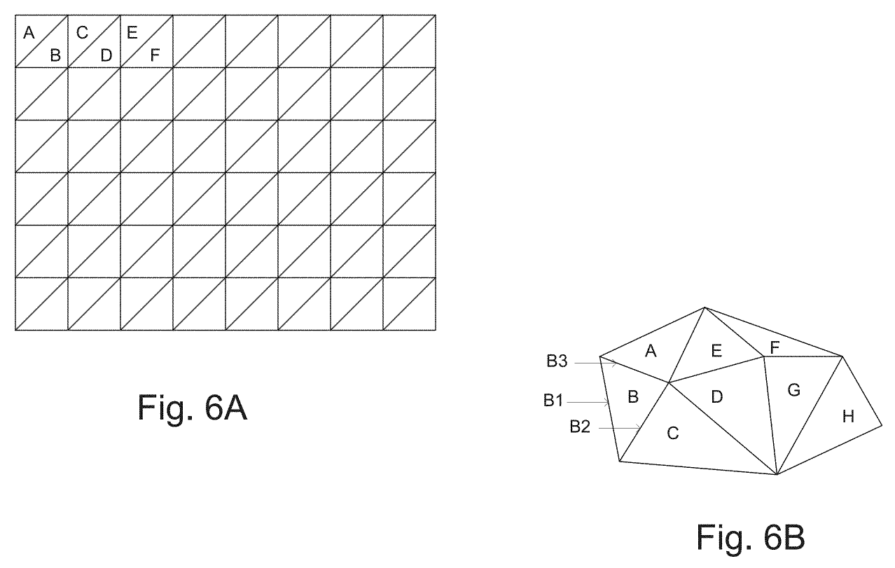

In some embodiments, the monitored space is divided into sectors or regions, and the location and tracking of an individual are accomplished by detecting the presence of the individual as he or she travels between the various sectors of the space. The process of several embodiments includes constructing (e.g., through Delaunay triangulation) a simplicial complex as a representation for the discrete space. Simplicial complexes in many embodiments are mathematical representations that, based on concepts from homology and homotopy, represent a space and allow for the efficient computation and storage of a path through the space. Each simplex can be associated with the respective coverage of a camera and/or an antenna of the RFID reader system. As noted above, a simplicial complex for a particular region can be automatically generated during an initial setup phase by moving a single object or entity through the monitored environment and recording points at which the object is observed by the various detection elements monitoring the environment. Simplicial complexes and their generation are described in further detail below, with reference to FIGS. 6A-B.

The first stage 501 of FIG. 5 illustrates that a first individual (indicated with an encircled 1) is detected within sector A of a space 500. Although the sectors in this example are shown as specific, and regular sections of the space to ease the discussion of this example, such a division of the space is not necessary in various embodiments of the invention. In some embodiments, sectors are defined based on which sensor (or group of sensors) are able to detect an entity. For example, in certain embodiments, a sector is defined when an entity is only visible in the viewing range of a first camera and a different sector is defined when the entity is visible in the viewing range of both the first camera and a second different camera.

When a new entity is detected, the joint entity and object tracking system of some embodiments records a new record to begin tracking of the new entity. If an identifier is not already associated with the person, the system can assign a person identifier. In some embodiments, tracking of the person can begin at a later point, such as when they pick up an object. In this example, the right side of the first stage 501 shows that the location of the first individual (“A”) is stored in table 550, along with an identifier (“1”) for the individual.

Referring back to FIG. 4, the process 400 then tracks (412) routes of the individuals as they travel through the space. In many embodiments, the vision system can continue to track the person as they traverse the space. Alternatively, or conjunctively, other detection systems, such as a LiFi system or motion detectors, are used to detect the path of entities through the space. In many embodiments, when the detection system detects the presence or motion of one or more individual in a region, the RFID system sends interrogation signals addressed to tags associated with individuals to identify and track the particular individual(s) that entered the region.

In certain embodiments, the paths of the entities are recorded as sensor words. A sensor word describes simplices along the path that a person moves. A sensor word can include a sequence of labels that identify each simplex and the side(s) of the simplex that the person enters and/or exits as the person travels along a path. Many methods for recording the paths of individuals are envisioned, but a method based on the calculation of simplicial complexes, is described below.

While specific processes for locating and tracking an individual in space are described above, any of a variety of processes can be utilized to locate and track an individual through a space as appropriate to the requirements of specific applications.

In some embodiments, as the individuals are tracked through the space, the process 400 associates (414) tags with the different individuals. In order to associate a tag with an individual, the process of some embodiments determines that a tag has moved or that the person picks up an item and/or places the item in a basket or cart. Detection of the tag's movement may be triggered by any of a number of methods, such as, but not limited to: image recognition, motion sensors, GPS sensors, and/or RFID location tracking of the tag. In several embodiments, the process 400 detects the tag's movement by targeting a series of RFID interrogation signals in an area, based on the detection of entities in an area, and uses the series of RFID response signals to identify the movement of a RFID tag using information including (but not limited to) radiometric information such as phase offsets detected from backscattered signals during successive reads of a particular RFID tag at a given frequency and/or phase offsets detected from backscattered signals during successive reads at different frequencies.

The process then identifies a corresponding individual that triggered the particular tag to associate with the tag. Some embodiments identify the corresponding individual based on the detection sensors, such as through vision, in conjunction with the RFID system to identify an entity in proximity of the tag. In some cases, the simple detection of the presence of an individual is not sufficient to identify a specific individual to be associated with the tag, particularly when there are many individuals within a given region. In many embodiments, when the detection system detects the presence or motion of an individual in a region with a newly triggered tag, the RFID system sends interrogation signals to the region, addressed to tags associated with individuals, to identify the particular individual to be associated with the new tag based on the response signals that are backscattered by tags within the region. Alternatively or conjunctively, the process of many embodiments associates a new tag with an individual based on a route for the tag and the correspondence of the route with other tags already associated with the individual. For example, in several embodiments, the process determines that a new tag has begun moving with a group of other tags associated with a particular entity, and associates the new tag with the particular entity. In some embodiments, groups, or particular combinations, of tags are associated with an entity, allowing the process to unambiguously identify an entity based on the readings of multiple tags associated with the entity.

In certain embodiments, the process 400 reads the tag to identify the object to be associated with the entity using an EPC code from the tag. Such tags can have an item identifier code embedded or another identifier from which the item identifier code can be looked up in a database. An item can be identified by an item identifier code such as a stock keeping unit (SKU). The process of many embodiments identifies a set of characteristics of the item, such as (but not limited to) the item type, category, or other description of the item.

In other embodiments, the item is identified using image recognition on images captured by one or more cameras in the vision system and item identifier codes stored with computer models or algorithms that are associated with the respective item type. In many embodiments, the item is recognized both by the vision system and the RFID reader system and the two separate determinations are compared for a match. Remedial measures can be taken if there is not a match. For example, if the EPC code is read with high confidence, the image recognition process may be refined to gain a higher confidence of a match, or if the image recognition has a high confidence then the tag may be read again to check whether the EPC code is correct.

Referring back to FIG. 5, the second stage 502 shows that the first individual has traveled from sector A to sector B, and that the user has become associated with a tag x. An individual becomes associated with a tag in various ways in various embodiments of the invention. For example, in some embodiments, an individual is associated with a tag when the individual is identified in a region with the item that is moved, such as when the individual handles the item to which the tag is attached or when the item is placed in a shopping cart of the individual. In some such embodiments, the individual is identified in the region by targeting interrogation signals in the region for tags associated with multiple individuals and by reading the response signals to determine which tags are actually present in the region. Alternatively, or conjunctively, the system identifies a correlation between a moved tag's trajectory and the trajectories of other tags associated with one of the individuals identified in the region. The second stage 502 further shows that a second individual has been located in sector A.

The right side of the second stage 502 shows that the route (AB) of the first individual is stored in table 550, indicating that the first individual has traveled from sector A to sector B. Table 550 further shows that the first individual has been associated with tag x. The location of the second individual is also stored in table 550, along with an identifier (“2”) for the individual.

Upon associating the tag with an entity, the process 400, according to some embodiments of the invention, targets (416) interrogations for a set of tags associated with an individual based on their detected location in the space. The targeted interrogations allow the process of some embodiments to get additional information about an individual based on tags associated with the individual. In many embodiments, the subsequent targeted interrogations allow the system to track a specific individual as they travel through the space. Alternatively, or conjunctively, the subsequent targeted interrogations can be used to identify other information about the individual, including (but not limited to) a trajectory for the user within a region, a velocity at which the user is traveling, and time spent stopped in a particular location within a region. Unlike previous targeted signals used to detect motion and associate tags, these targeted signals detect the motion of tags already associated with an entity to distinguish. Some embodiments of the process 400 fire specific interrogation signals for the identified tag. Alternatively, or conjunctively, the process 400 fires interrogation signals from a particular subset of the antennas in the identified region, and then filter the responsive signals for the particular tag to determine information about the tag, including (but not limited to) a range to the tag, a trajectory of the tag, and/or presence of the tag in the identified region. The use of such targeted interrogation signals allows for efficient and focused tracking of tags and entities through a space with many tags and entities.

The third stage 503 shows that the first and second individuals have both entered sector C, which contains tag y. The third stage 503 also shows that the tag y has been moved, indicating that it should be associated with one of the first and second individuals, but it is not necessarily clear which individual the item should be associated with.

In some embodiments, the tracking system (e.g., machine vision based camera system) operates at a coarse level of detail, allowing the tracking system to determine that both individuals are in sector C, but making it difficult to determine which individual is to be associated with tag y. This becomes an even more difficult problem as the number of individuals and the number of tags increases. In the example of FIG. 5, although the tag y has been moved, it remains unclear whether it should be associated with the first or the second user. Beyond associating the tags with the individuals, it can become unclear which individual is moving between various sectors. For example, in the example of FIG. 5, without specific identification of each individual as they move through a sector, it can be difficult to determine which individual left sector C for sector A and which individual left for sector D. Accordingly, the system of some embodiments uses the RFID information to distinguish between multiple entities and to associate each object with the appropriate entity.

The process 400 records (418) the route for each individual based on associated tag and sensor data. The item identifier code is stored with the sensor word that describes the person's path through the area. In some embodiments, radiometric data of a backscattered signal received from a RFID tag by the RFID reader system is also stored with the sensor word. In many embodiments, the RFID reader system can determine the location of the tag and stores the location with the sensor word.

The sensor word is typically completed when the vision system determines that the person exits the area or has a trajectory that satisfies a specific transition criterion. Another waypoint or end point could be when the person checks out at a point-of-sale terminal (e.g., cashier) or other suitable conclusion point. In several embodiments, point-of-sale information, such as, but not limited to, purchase amount and type of payment is stored with the sensor word. Any or all of the above may be performed for each person i that is in the space or enters the space in series or in parallel.

The various stored sensor words can then be analyzed to provide valuable information regarding the effectiveness of various space layouts. For example, in the case of retail space, the tracking information can provide information on where customers are walking, their dwell times (i.e., how long customers are staying in a particular area), and when customers are picking up or putting down items, allowing a manager to adjust floor layouts, and product and/or marketing placements accordingly. Such decisions can be made with enriched customer information, allowing a manager to analyze the routes and store traffic based on various classes of customers (e.g., based on associated tagged items).

### Simplicial Complexes

As described above, some embodiments of the system use simplicial complexes to represent a space and to record an entity's traversal of the space. A discrete area, such as a retail floor within a store, can be represented as a two-dimensional mathematical space such as a topological space. In many embodiments of the invention, a space can be represented by a simplicial complex. A simplicial complex is generally defined as a set of simplices that satisfies the following conditions:

Any face of a simplex from K is also in K.

The intersection of any two simplices σ₁, σ₂ ϵ K is either Ø or a face of both σ₁ and σ₂.

A simplicial k-complex [symbol] is generally defined as a simplicial complex where the largest dimension of any simplex in [symbol] equals k. For instance, a simplicial 2-complex must contain at least one triangle, and must not contain any tetrahedra or higher-dimensional simplices.

A construct that can be used to generate a simplicial complex in accordance with many embodiments of the invention is Delaunay triangulation. The Delaunay triangulation of a point set S, is characterized by the empty circumdisk property: no point in S lies in the interior of any triangle's circumscribing disk. In other embodiments, other constructs or restrictions may be used in constructing a simplicial complex. For example, another general construct can be characterized in that all vertices of adjacent sides of triangles meet in the same place (are a common vertex) and shared sides of adjacent triangles are congruent. In several embodiments, a notation of an alphabet and number combination can be used. FIGS. 5A and 5B illustrate examples of different simplicial complexes that can be used to represent a two-dimensional space in accordance with embodiments of the invention. In the example illustrated in FIG. 5A, simplexes may be symmetric and line up into rows and columns and labeled A, B, C and so on. In the example illustrated in FIG. 5B, B1 and B1—can represent entering and leaving cell B from side B1, respectively. Additionally, a sensor word can be expressed as AB⁻¹CDC⁻¹B. Other types of notations may be utilized as appropriate to the particular application. In this way, locations and paths taken by a person and/or object through the space can be represented as a sensor word that includes the sequence of simplices that are passed through with the direction of travel. This allows for a coordinate-free system where the actual locations of cameras are not necessary to define it.

When a simplicial complex is defined for the particular area, paths taken through the area can be seen as a sequence of simplices. Obstacles such as shelves or racks in a person's path can be represented as holes and homotopic paths can have the same representation. Similar paths can be classified as equivalence classes. When obstacles are moved, a linear matrix transformation can be applied to update the model. Further embodiments may utilize one simplicial complex system for tracking a person and a separate simplicial complex system for tracking an RFID tag attached to an object, where the person may pick up the object at some point and thereby the person and object become associated with each other. The combination of the two simplicial complex systems can be produced as the Cartesian product.

Representing a retail space or other discrete area as a two-dimensional simplicial complex in accordance with embodiments of the invention allows for efficient definition and storage of paths taken by a person or object through the area using simplicial homology. Furthermore, machine learning can be used to determine an optimal simplicial complex by using training data of people navigating the monitored space. Additional embodiments may utilize other types of geometric and mathematic representations as appropriate to the particular application. For example, discrete differential geometry may be used.

Although the description above contains many specificities, these should not be construed as limiting the scope of the invention but as merely providing illustrations of some of the presently preferred embodiments of the invention. Various other embodiments are possible within its scope. Accordingly, the scope of the invention should be determined not by the embodiments illustrated, but by the appended claims and their equivalents.

What is claimed:

1. A method for monitoring entities in a physical space, the method comprising:
detecting a set of entities in the physical space using a detection system comprising a plurality of cameras having different fields of view, wherein the detection system detects the presence of entities within each camera's field of view;
tracking a path for each entity of the set of entities through the physical space based on the detection system;
performing a set of tag reads to detect movement of tags proximate to a region in which a particular entity is detected by the detection system;
associating a particular tag with the particular entity and a corresponding path of the particular entity based on the detected movement of the particular tag; and
recording the corresponding path for each entity based on the set of tag reads, the detected presence of the set of entities, and tags associated with at least one entity of the set of entities.

2. The method of claim 1 further comprising:
transmitting interrogation signals addressed to a particular tag associated with a particular entity;
computing location data from response signals received from the particular tag associated with the particular entity; and
updating the corresponding path for the particular entity based on the computed location data.

3. The method of claim 1, wherein the detection system further comprises a set of beacons for a Light-Fidelity (Li-Fi) system, wherein detecting a set of entities comprises receiving detection data based on the set of beacons from mobile devices associated with each entity of the set of entities.

4. The method of claim 1, wherein the detection system further comprises a set of motion detectors, wherein detecting a set of entities comprises using the set of motion detectors to detect motion of the entities within the physical space.

5. The method of claim 1, wherein tracking a path for each entity comprises:
identifying bounded regions within the field of view of each camera of the plurality of cameras;
detecting the presence of a particular object within a bounded region of the field of view of a particular camera of the plurality of cameras;
determining movements across boundaries between bounded regions; and
storing the path as a sequence of transitions across boundaries of the bounded regions, where the description of the transition includes the direction of the transition.

6. The method of claim 5, wherein storing the trajectories comprises building a sensor word to express the path of the entity based on the transitions between the boundaries of the bounded regions.

7. The method of claim 1, wherein performing the set of tag reads to detect movement of a tag comprises determining that the tag has moved based on radiometric properties of response signals received in response to a set of interrogation signals.

8. The method of claim 7, wherein the radiometric properties comprise at least one of a frequency and phase offsets of the response signals.

9. The method of claim 7, wherein the set of interrogation signals comprises a plurality of interrogation signals sent to the tag at a single frequency.

10. The method of claim 7, wherein the set of interrogation signals comprises a plurality of interrogation signals sent to the tag at multiple, different frequencies.

11. The method of claim 1, wherein performing the set of tag reads comprises reading a tag identifier from a response signal associated with each tag and associating the particular tag with the particular entity based on the detected movement of the particular tag comprises associating the tag identifier for the particular tag with the entity.

12. The method of claim 1 further comprising:
upon associating a tag with an entity, detecting the entity in a particular region of the physical space;
targeting interrogation signals for the associated tag in the particular region of the physical space; and
analyzing response signals from the targeted interrogation signals to infer movement of the entity based on movement of the associated tag.

13. The method of claim 1 further comprising:
upon associating a tag with an entity, detecting the entity in a particular region of the physical space;
targeting interrogation signals for the associated tag in neighboring regions of the physical space;
analyzing response signals from the targeted interrogation signals to locate the tag; and
identifying a step in the path of the entity based on a location of the associated tag.

14. A system for monitoring entities in a physical space, the system comprising:
a detection system for detecting a set of entities in the physical space, the detection system comprising a plurality of cameras having different fields of view, wherein the detection system detects the presence of entities within each camera's field of view;
a RFID reader system for performing a set of tag reads to detect movement of tags proximate to a region in which a particular entity is detected by the detection system;
a path tracking system for tracking a path for each entity of the set of entities through the physical space and for associating a particular tag with the particular entity and a corresponding path of the particular entity based on detected movement of the particular tag; and
a tracking database for recording the corresponding path for each entity based on the set of tag reads, the detected presence of the set of entities, and tags associated with at least one entity of the set of entities.

15. The system of claim 14, wherein the RFID reader system is further for:
transmitting interrogation signals addressed to a particular tag associated with a particular entity; and
computing location data from response signals received from the particular tag associated with the particular entity,
wherein the path tracking system is further for updating the corresponding path for the particular entity based on the computed location data in the tracking database.

16. The system of claim 14, wherein the detection system further comprises a set of beacons for a Light-Fidelity (Li-Fi) system, wherein the detection system detects a set of entities by receiving detection data based on the set of beacons from mobile devices associated with each entity of the set of entities.

17. The system of claim 14, wherein the path tracking system tracks a path for each entity by:
identifying bounded regions within the field of view of each camera of the plurality of cameras;
detecting the presence of a particular object within a bounded region of the field of view of a particular camera of the plurality of cameras;
determining movements across boundaries between bounded regions; and
storing trajectories as a sequence of transitions across boundaries of the bounded regions, where the description of the transition includes the direction of the transition.

18. The system of claim 17, wherein the stored trajectories are stored as sensor words that express the path of the entity based on the transitions between the boundaries of the bounded regions.

19. The system of claim 14, wherein the RFID reader system is further for determining that the tag has moved based on radiometric properties of response signals from the set of interrogation reads.

20. The system of claim 14, wherein the detection system is further for, upon associating a tag with an entity, detecting the entity in a particular region of the physical space,
wherein, upon detecting the entity in the particular region, the RFID reader system is further for targeting interrogation signals for the associated tag in neighboring regions of the physical space,
wherein the path tracking system is further for:
analyzing response signals from the targeted interrogation signals to locate the tag; and
identifying a step in the path of the entity based on a location of the associated tag.
